(19) United States
(12) Patent Application Publication
(10) Pub. No.: US 2005/0271394 A1
(43) Pub. Date: Dec. 8, 2005

(54) Filter to improve dispersion tolerance for optical transmission

(76) Inventors: James Whiteaway, Sawbridgeworth (GB); Richard Heath, Epping (GB); Gary Pettitt, Bishops Stortford (GB); Paul Bruce, Bishops Stortford (GB)

Correspondence Address: BARNES & THORNBURG, P.O. BOX 2786, CHICAGO, IL, 60690-2786, US

(21) Appl. No.: 10/859,406

(22) Filed: Jun. 2, 2004

(51) Int. Cl. H04B 10/04

(52) U.S. Cl. 398/188

(57) ABSTRACT

An optical transmission system has a directly modulated laser for modulating data directly on an optical signal, and a narrow band optical filter having a band center frequency offset from a central optical frequency of the optical signal, to reduce the phase difference between FM and AM of the modulated optical signal, the filter having a bandwidth sufficiently narrow to substantially remove frequencies outside a spectrum of adiabatic frequency chirp resulting from the modulation, combined with Fourier broadening caused by the data modulation. This is a cost effective way of improving the dispersion tolerance to give greatly improved system reach and to make it practical to use directly modulated lasers with existing NDSF. The narrow band filter can be located at the transmitter or the receiver, and can have a center frequency locked to a feature in the frequency spectrum of the laser.

### FIELD OF THE INVENTION

This invention relates to systems for optical transmission, to receivers or transmitters for such systems, and to methods of offering a transmission service over such apparatus.

### BACKGROUND TO THE INVENTION

It is known to transmit optical signals in long-haul dense wavelength division multiplexed (DWDM) networks, using directly modulated DFB (distributed feed back) lasers. The principal advantage of such lasers is their low-cost and straightforward implementation. However, system performance in terms of reach, can be limited by frequency chirping, which results in pulse broadening in a dispersive single-mode fiber. Another limiting effect is wavelength drift due to aging of the laser.

It is known from IEEE PHOTONICS TECHNOLOGY LETTERS, VOL. 13, NO. 1, JANUARY 2001 pages 58-60 that temporal reshaping of the optical pulses by filtering the output of a directly modulated transmitter can decrease the dispersion penalty. The filter can be a Fabry-Perot (FP) interferometer or a fiber Bragg grating (FBG). The extinction ratio of a signal having adiabatic frequency chirp becomes improved by transmitting the signal through a spectral filter with a transmission spectrum having a positive slope with frequency. Adiabatic chirp is the optical frequency difference between the data states, usually “1” and “0”. The relaxation oscillations at the edges of the pulse can increase in the presence of a filter, tuned onto the positive slope with frequency. The filter shown is 14 GHz wide and transient effects are not filtered out. In this article a tunable optical filter for simultaneous spectral filtering and wavelength monitoring of the output of the laser is proposed. The wavelength of this operating point is varied by temperature control, to be locked to the wavelength of the laser, to counter the problem of laser wavelength drift. The laser is a directly modulated DFB laser, (and so will output a mix of amplitude modulation and frequency modulation) with a 2.5 Gb/s data rate. The FP filter used had a −3 dB bandwidth of 14 GHz.

This is an example of an optical filter used largely for its power transmission response. Other known filters are used to provide dispersion compensation to effectively compensate for some or all of the fibre dispersion. The former approach reduces the susceptibility of a transmitted waveform to dispersion, whereas the latter deliberately introduces dispersion with an opposite sign to that in the fibre to provide compensation. Such filters are used in dispersion compensation modules. These can use FBGs or dispersion compensating fiber (DCF), or other passive components such as etalon or FP cavities, but again there is a cost penalty. (It is possible to envisage a FBG or FP cavity providing a filter function to reshape the transmitted waveform rather than give dispersion compensation. A DCF only provides dispersion compensation.) For higher bit rates, the chromatic dispersion typically limits the transmission distance of a 10 Gb/s directly modulated DFB laser to about 10 km of NDSF (non dispersion shifted fiber). The use of an expensive external modulator might extend this to about 100 km of NDSF. This is essentially because such external modulators can provide independent control of frequency and amplitude. They can for example provide amplitude modulation with low frequency chirp, or be used to deliberately pre-chirp the waveform to provide an element of dispersion compensation. However, in a directly modulated laser, a change in current results in a change in the injected carrier density, which in turn alters the frequency and the gain. The former gives the frequency chirp, and the gain change then results in an increase or decrease in the photon density and hence the output power. The change in output power therefore always lags the change in frequency. External modulators based on the Quantum Confined Stark Effect or Franz Keldysh Effect, or utilising a Mach-Zehnder interferometer, can achieve approximately 100 km of transmission over NDSF, but they are relatively expensive. The reach can be extended somewhat by tailoring the frequency chirp introduced by the modulator as mentioned above.

Directly modulated lasers operated at 10 Gb/s suffer from a particularly strong dispersion penalty at about 1000 ps/nm of chromatic dispersion. The reach is limited to about 10 km of NDSF even when using an adaptive threshold receiver.

Conventional understanding attributes this dispersion penalty to the transient effects associated with switching a laser between the ‘zero’ and ‘one’ levels, as shown in K. Inoue, ‘Optical filtering to reduce chirping influence in LD wavelength conversion’, IEEE Photonics Technology Letters, vol. 8, no. 6, June 1996, pp. 770-2. and in C-H. Lee, S-S. Lee, H. K. Kim and J-H. Han, ‘Transmission of directly modulated 2.5-Gb/s signals over 250-km of nondispersion-shifted fiber using a spectral filtering method’, IEEE Photonics Technology Letters, vol. 8, no. 12, December 1996, pp. 1725-27.

It is known to use frequency shift keying (FSK) as well as or instead of amplitude shift keying, to help overcome the dispersion limitation. Advantages of FSK with or without ASK include the following: ASK requires the use of a high extinction ratio from the transmitter, and hence the current in the ‘zeros’ must be close to threshold, as the maximum current in the ‘ones’ is limited by the reliability of the laser source. Under these conditions, switching from a current close to threshold up to a higher current requires that the photon density is built up from a low level to a high one in a short time period. This gives rise to a damped oscillatory transient response, which is well understood and described by the carrier and photon rate equations. In general, the higher the extinction ratio, the larger are the transients in power and frequency. In FSK the laser can be biased well above threshold and the current modulation set at a level that gives the appropriate FSK. There will be attendant ASK but the extinction ratio will be low. This greatly reduces transient effects, and in addition the optical filter acts to give a high extinction ratio by preferentially filtering out the power in the ‘zeros’. Such systems would use a FSK modulation depth of 10-30 GHz and an optical filter at the receiver having a positive sloping frequency response to convert FM into AM. (A negative slope with frequency would favour the power in the ‘zeros’ over the ‘ones’ which is unlikely to be useful on account of the lower transmitted power).

Another known arrangement is shown in H-Y. Yu, D. Mahgerefteh, P. S. Cho and J. Goldhar, ‘Improved transmission of chirped signals from semiconductor optical devices by pulse reshaping using a fiber Bragg grating filter’, Journal of Lightwave Technology, vol. 17, no. 5, May 1999, pp. 898-903. Here, some of the dispersion penalty from frequency chirp contributed by an optical amplifier, is attributed to the FM response being out of phase with (leading) the AM response. This means that each data value “one”, represented by an amplitude peak, is effectively out of phase with a corresponding frequency peak. The document proposes pulse reshaping using a high pass filter formed from a fiber Bragg grating. After the grating, the entire pulse has the same sign of the instantaneous frequency, leading to a slower pulse broadening upon propagation in fiber. This phase/amplitude relation is said to be similar to the adiabatic chirp of directly modulated lasers, and so could be applied to improve their performance.

### SUMMARY OF THE INVENTION

It is an object of the present invention to provide improved apparatus and methods. According to a first aspect of the present invention, there is provided a system having a transmitter for transmitting an optical signal along a transmission path, the transmitter having a directly modulated laser for modulating data directly on the optical signal, the system having a receiver for receiving the transmitted optical signals to recover the data, and a narrow band optical filter having a band center frequency offset from a central optical frequency of the optical signal, to reduce a phase difference between FM and AM of the modulated optical signal, the filter having a bandwidth sufficiently narrow to substantially remove damped oscillatory transients in frequency that fall outside the spectrum of adiabatic frequency chirp resulting from the modulation, combined with Fourier broadening caused by the data.

This exploits a realization that the dispersion penalty of directly modulated lasers has two principal fundamental causes, either of which can be significant, and so both need to be dealt with, and can be with relatively inexpensive optical filtering. This can produce dramatic improvements in dispersion tolerance which are not apparent when either one of the causes is addressed without addressing the other. This improved dispersion tolerance can give greatly improved system reach, or this reach can be traded for other system improvements such as reduced error rate, or increased power margins or cheaper components for example. This system performance improvement is particularly significant in enabling use of conventional directly modulated lasers in higher performance transmission systems such as 2.5 and 10 Gb/s systems, over existing NDSF type installed fiber, where previously only the more expensive externally modulated transmitters were practical. The advantages are not limited to use with NDSF type fiber, other types of fiber can be used.

The two principal causes of the dispersion penalty are now seen to be transient frequency chirp associated with the damped oscillatory response of the laser, and the delay of the AM compared to the FM which means that the power in the ‘ones’ and ‘zeros’ is each distributed over a wide range of frequencies. The former can produce a dispersion penalty which increases at longer distances. The latter gives a penalty particularly at shorter distances, and occurs even for ASK (amplitude shift keying), since directly modulated lasers usually produce some unwanted adiabatic frequency chirp. The first cause is addressed by making the bandwidth narrow enough to substantially remove frequencies outside the spectrum of the desired data, to enable removal of most of the transient frequency chirp or ringing. The second cause is addressed by the offset of the centre frequency of the filter, from the average frequency in the ‘ones’ and ‘zeros’, to approximately the frequency in the ‘ones’, so as to reduce or remove the phase difference between the AM and FM. This effect can be largely understood by considering a waveform with a sinusoidal amplitude variation combined with an in-phase frequency variation. The resulting spectrum is asymmetric. Likewise if the sinusoidal frequency variation is in anti-phase with the amplitude variation, then again an asymmetric spectrum results, but with the opposite sign of asymmetry. In the case of a quadrature relationship between the amplitude and frequency variation, as holds approximately for a semiconductor laser, the spectrum is symmetric. It can therefore be seen that an appropriate filter offset from the centre of the spectrum can introduce the asymmetry required to bring the frequency and amplitude variations into phase with each other. Together these two measures can enable the system reach to be extended sufficiently to make directly modulated lasers a practical option.

The filter can be located anywhere in the optical path in principle, including the transmitter or the receiver. This is because dispersion is a linear process, so if non linear processes such as the Kerr effect in optical fibre at high optical power, are disregarded, then in principle, the dispersive transmission fiber can be before or after the filter. The narrow band filter can be made up of separate high and low pass filters, which need not be co-located, and in principle one could be at the receiver and the other at the transmitter.

An additional feature for a dependent claim is the filter bandwidth being narrower than the spectrum of adiabatic frequency chirp resulting from the modulation, combined with Fourier broadening caused by the data.

Such a narrow band filter effectively sacrifices some of the power representing the desired data in the optical signal, but gains an improvement in dispersion tolerance. In other words the transient frequency chirp is substantially reduced at the expense of some closure of the back-to-back eye diagram. This can lead to a surprising improvement in system performance because the improved dispersion tolerance can outweigh the effect of the loss of power of the desired data in the signal.

An additional feature for a dependent claim is frequency modulation with a magnitude of less than twice the data rate (i.e. less than 20 GHz at 10 Gb/s).

This is a relatively low amount of modulation. The magnitude of the frequency modulation is a compromise. As it gets larger, the dispersion penalty increases because the amount of the spreading of the pulses in time, induced by the dispersive fiber, is proportional to the range of frequencies. However, as the magnitude of the FSK is made smaller, it becomes increasingly difficult to separate the power in the ‘ones’ and ‘zeros’ with an optical filter given the Fourier broadening. The extinction ratio therefore becomes smaller, and it becomes harder to distinguish the data at the receiver. The extinction ratio will be partly set by the amount of amplitude modulation transmitted, which will be intimately related to the frequency modulation, since directly modulated lasers always produce a mixture of AM and FM. In addition, a filter in the optical path can be used to convert some or all of the FM to AM, to increase the extinction ratio at the receiver.

An additional feature for a dependent claim is the transmitter being arranged such that the magnitude of the frequency modulation is approximately half the data rate. This is a good compromise for higher data rates particularly. It corresponds to a minimum shift keyed system (i.e. ˜5 GHz at 10 Gb/s).

An additional feature for a dependent claim is the system having active control of the center frequency of the filter band relative to the center frequency of the optical signal. This can help address the above mentioned issue of the laser being susceptible to wavelength drift. This drift can be a function of age and temperature and current. There is usually some coarse control of the laser wavelength, but for such narrow band filters, either finer control of the laser would be needed, or some active relative control.

An additional feature for a dependent claim is the filter center frequency being controlled based on a monitored quality of a received signal at the receiver.

This can encompass for example an output of a bit error detector, an error corrector, or Q or eye opening values, or others. This enables the filter to track changes in laser wavelength and other system changes such as temperature. Measures may need to be taken to avoid loss of control if other factors affect the signal quality badly. The filter need not be at the receiver, if a control signal can be fed back to its location which might be at the transmitter.

An additional feature for a dependent claim is the filter center frequency being controlled based on the optical signal power after the filter.

This is an alternative which can be simpler and cheaper to implement, and can make the filter control less dependent on other sources of errors. The average output power can be measured at the output of the filter, or further downstream, and the filter controlled to maximize that power. Alternatively, with a Mach-Zehner (MZ) filter there might be two outputs, so that minimizing the average power from one output should maximize that from the other. This can be used easily where there is mixed amplitude modulation and frequency modulation, so that the filter will be centered near the frequency representing the “1” modulation level, offset from a center frequency of the optical signal.

An additional feature for a dependent claim is the receiver being arranged to receive optical signals having a number of WDM channels, and the filter being arranged to pass one desired channel or band of channels, and reject the others. This can enable the expensive de-multiplexing filter(s) to be removed from the receiver for a WDM system. This can be achieved if the free spectral range (FSR) of the narrow optical filter is large enough to reject all channels other than the one desired channel or band of channels for example. In other words the receiver is frequency selective as a result of the narrow optical filter function with a large FSR. A combination of filters can be used to achieve the effect of a narrow optical filter with a large FSR, such as a Mach-Zehnder with a small FSR, and another filter with a broader bandwidth and large FSR for example.

An additional feature for a dependent claim is the filter comprising a MZ with an adjustable path length difference.

This is one way of implementing a relatively narrow band filter with fine control of wavelength. It gives a raised cosine power transmission response, which has similarities to a Gaussian filter response. A FP filter response by comparison has wider ‘tails’. Another alternative is a FBG. The MZ can be arranged to have two outputs, one of which can be used for output power monitoring if desired. Alternatively the filter can be FP (Fabry Perot, FBG (Fiber Bragg Grating), or Gaussian type. Gaussian and Mach-Zehnder filters can give closer to optimum performance, while the use of a FP filter gives poorer performance and requires a narrower −3 dB bandwidth than for a Gaussian filter.

An additional feature for a dependent claim is the receiver having an electrical signal processor arranged to carry out sequence detection to decode the data.

Sequence detectors encompass MAP and MLSE types for example, usually implemented in digital signal processing circuitry. This can enable better system performance than alternatives such as adaptive decoders, which do not adapt directly to inter-symbol interference (ISI) from preceding or succeeding bits in the received stream. In particular, it enables any deterministic impairments to be recovered. Thus signals can suffer greater degradation before or during transmission along a dispersive path, and still be recovered. For example, a narrow optical filter might introduce ISI but reduce dispersive effects. The MLSE might then be used to recover most of the impairment introduced by the ISI, leaving an improved dispersion tolerance. It can be offered optionally as a later system upgrade, as the circuitry to implement it becomes more widely available and cheaper with time.

An additional feature for a dependent claim is the receiver having forward error correction (FEC) circuitry.

This is a well established technique which reduces transmission capacity to gain reach or other performance benefits. Again this can optionally be offered as a later upgrade.

An additional feature for a dependent claim is the filter being located at the receiver. This enables the filter to be controlled more easily based on receiver error signals, and enables the filter to remove noise added along the transmission path by optical amplifiers for example.

An additional feature for a dependent claim is the filter being located at the transmitter. This is useful if the filter is to be controlled relative to the laser wavelength, since there is no longer a lengthy feedback path. The wavelength of lasers is often coarsely controlled using frequency selective elements such as etalon filters. The narrow optical filter required for the reduction of dispersive effects could be the same component as a laser locker filter

Another aspect of the invention provides a system having a transmitter for transmitting an optical signal along a transmission path, the transmitter being arranged to modulate data on the optical signal, the system having a receiver for receiving the transmitted optical signals to recover the data, and a narrow band optical filter for passing frequencies at one side of a central optical frequency of the optical signal, the modulation comprising frequency modulation with a magnitude less than approximately twice a rate of the data.

This is a relatively small amount of frequency modulation, but the benefit of reduced dispersion penalty can outweigh the disadvantage of reduced extinction ratio at the receiver.

An additional feature for a dependent claim is the transmitter having a directly modulated laser.

This can enable a simpler more cost effective transmitter, than if an external modulator is needed.

Another aspect of the invention provides a transmitter for transmitting an optical signal along a transmission path, the transmitter having a directly modulated laser for modulating data directly on the optical signal, and a narrow band optical filter having a band center frequency offset from a central optical frequency of the optical signal, to reduce a phase difference between FM and AM of the modulated optical signal, the filter having a bandwidth sufficiently narrow to substantially remove frequencies outside a spectrum of adiabatic frequency chirp resulting from the modulation, combined with Fourier broadening caused by the data.

Another aspect of the invention provides a receiver for receiving an optical signal modulated with data, to recover the data, and having a narrow band optical filter having a band center frequency offset from a central optical frequency of the optical signal, to reduce a phase difference between FM and AM of the modulated optical signal, the filter having a bandwidth sufficiently narrow to substantially remove transient chirp frequencies.

Another aspect of the invention provides a method of offering a communication service over an optical communication system having a transmitter for transmitting an optical signal along a transmission path, the transmitter having a directly modulated laser for modulating data directly on the optical signal, the system having a receiver for receiving the transmitted optical signals to recover the data, and a narrow band optical filter having a band center frequency offset from a central optical frequency of the optical signal, to reduce a phase difference between FM and AM of the modulated optical signal, the filter having a bandwidth sufficiently narrow to substantially remove frequencies outside a spectrum of adiabatic frequency chirp resulting from the modulation, combined with Fourier broadening caused by the data.

Another aspect of the invention provides a method of offering a communication service over an optical communication system having a transmitter for transmitting an optical signal along a transmission path, the transmitter being arranged to modulate data on the optical signal, the system having a receiver for receiving the transmitted optical signals to recover the data, and a narrow band optical filter for passing frequencies at one side of a central optical frequency of the optical signal, the modulation comprising frequency modulation with a magnitude less than approximately twice a rate of the data.

Another aspect of the invention provides a transmitter for transmitting an optical signal along a transmission path, the transmitter being arranged to modulate data on the optical signal and having a narrow band optical filter for passing frequencies at one side of a central optical frequency of the optical signal, the modulation comprising frequency modulation with a magnitude less than approximately twice a rate of the data.

Another aspect of the invention provides a receiver for receiving and for recovering data from an optical signal having the data modulated thereon, the modulation comprising frequency modulation with a magnitude less than approximately twice a rate of the data, the receiver having a narrow band optical filter for passing frequencies at one side of a central optical frequency of the optical signal.

The improved equipment can mean data transmission services over the network can be enhanced, and the value of such services can increase. Such increased value over the life of the system, could prove far greater than the sales value of the equipment.

Any of the features can be combined with any of the aspects of the invention as would be apparent to those skilled in the art. Other advantages will be apparent to those skilled in the art.

### BRIEF DESCRIPTION OF THE DRAWINGS

To show by way of example how the invention can be implemented, embodiments will now be described with reference to the figures in which:

FIG. 1 shows a graph indicating dispersion for a system before a filter is applied,

FIG. 2 shows a transmission system according to an embodiment of the invention having a narrow band offset filter at the receiver,

FIG. 3 shows a graph showing a frequency spectrum of an optical signal before filtering, and a characteristic of the filter of an embodiment superimposed,

FIG. 4 shows a receiver according to an embodiment,

FIG. 5 shows a decoder and detector for use as an alternative to the receiver of FIG. 4, or for use with the filter of FIG. 4, or with a filter at the transmitter,

FIG. 6 shows a transmitter according to an embodiment,

FIG. 7 shows a transmitter system according to an embodiment using an external modulator,

FIG. 8 shows an embodiment of a system with a transmitter using small or minimum shift FSK, without a narrowband filter,

FIG. 9 shows, an example of a probability distribution function (PDF) for MLSE

FIG. 10 shows a view of a trellis for the MLSE,

FIG. 11 shows a part of that trellis and

FIG. 12 shows functions of a sequence detector in the form of an MLSE.

### DETAILED DESCRIPTION OF PREFERRED EMBODIMENTS

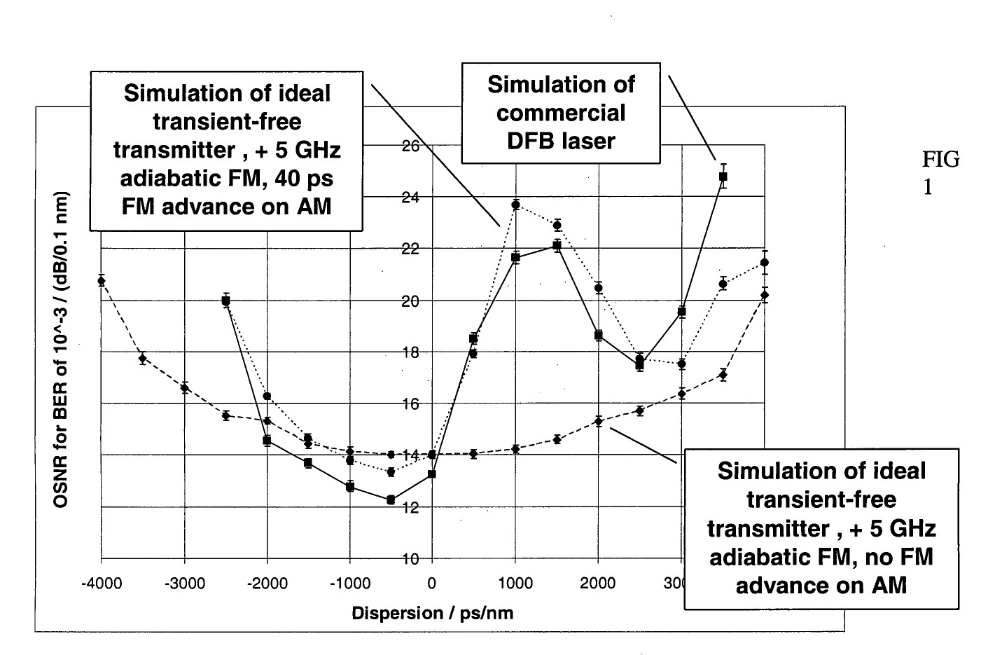

Directly modulated DFB lasers exhibit a damped oscillatory transient response in frequency and power when switched between ‘0’ and ‘1’ levels. They emit at different frequency in steady-state ‘0’ and ‘1’ levels, referred to as adiabatic frequency chirp. Notably adiabatic frequency chirp, combined with the delayed response of AM compared with FM, has been identified as the cause of a peak in the OSNR penalty for small positive dispersions (˜1000 ps/nm). The narrowband filter should reduce the FM timing advance on AM to approximately <10 ps to remove the dispersion penalty at ˜1000 ps/nm for 5 GHz of adiabatic FM (same holds when MLSE is used at the receiver). Transient effects can determine the performance at larger dispersion values (>4000 ps/nm). FIG. 1 shows schematically how the optical signal to noise ratio (OSNR) for a bit error rate (BER) of 10⁻³ varies with the dispersion. The horizontal axis can also represent distance along a dispersive fiber, and so the plotted curves show the tolerance of the system to optical noise at different dispersions or reaches at a BER of 10⁻³. A system with add-drop nodes will, for example, contain multiple optical amplifiers to compensate for the loss of the nodes. Hence the longer the system, the more amplifiers are generally needed, and the higher the added noise leading to a lower OSNR. The reach of the system can then be estimated by the intersection of a line describing the reduction in OSNR versus distance due to accumulating amplifier noise, with the appropriate curve in FIG. 1. The values are for a single channel system, with performance assessed by noise loading (measured in 0.1 nm optical bandwidth) to achieve a BER of 10⁻³ (assumed recoverable to 10⁻¹⁵ by FEC). Distance estimations can be derived based on linear propagation simulations for NDSF at 1550 nm, by including an approximate margin for multi-channel effects. 15 dB OSNR (in 0.1 nm bandwidth) can be used as a benchmark target OSNR. Three lines are shown for different transmitters, a first one representing the simulated performance of a typical directly modulated laser which is in good agreement with measurements. The second shows simulations for a case with no transient chirp, but otherwise similar to the real laser, in that FM to AM phase difference is not corrected. The third line is for simulation of an ideal laser with no transient chirp and with correction of FM-AM phase difference. This shows schematically that a dramatic improvement in reach is possible if both of these causes of dispersion penalty can be addressed.

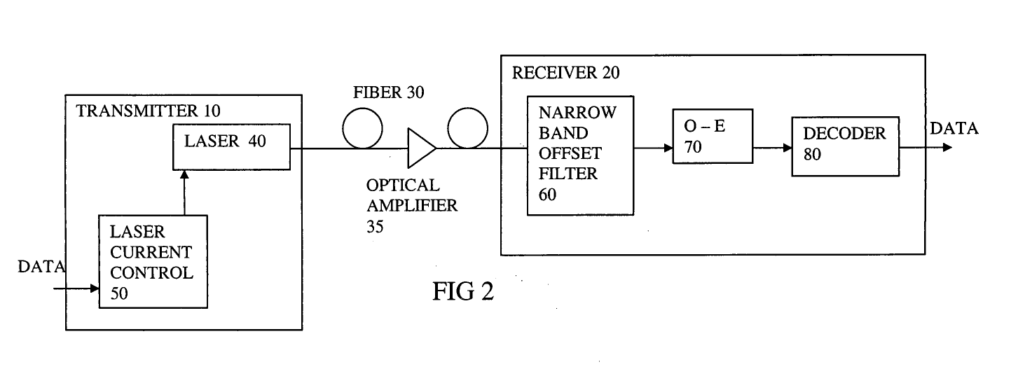

FIG. 2, System with Narrow Band Filter

FIG. 2 shows an embodiment having a transmitter 10, for transmitting data modulated onto an optical signal along a fiber 30, and a receiver 20 for receiving the optical signal to recover the data. The fiber optionally has one or more optical amplifiers 35 at intermediate points to boost the power. The transmitter has a laser 40 directly modulated by means usually of current control, by a laser current control part 50. The data is fed to the control part which outputs a current control signal to achieve modulation of frequency, phase or amplitude or a mixture, as desired. A wide range of modulation formats can be conceived, including:
ASK—Conventional binary on/off format—dispersion limited by laser chirp characteristics. Variants include PAM—multi level amplitude information—which is limited by the noise characteristics.
FSK—The laser frequency is modulated directly with the bit pattern, but only the ‘1s’ are received. The ‘0s’ are filtered out with a narrow offset filter, converting the data back to ASK.
PSK—In ideal PSK the amplitude is constant and the phase is rotated. In reality the laser is pulsed with current to achieve a rr phase shift whenever say a ‘1’ is required, with parasitic amplitude modulation also occurring. The information is decoded at the receiver with a fiber interferometer providing a 1 bit delay.
QPSK—In ideal QPSK the amplitude is constant and the phase is rotated. In reality the laser is pulsed with current to achieve the appropriate phase shift so as to move to the required state in the 4-state constellation, with again parasitic amplitude modulation occurring. The 4 states are equally spaced π/2 radians apart in phase space. Transmission of 2 bits/symbol can be achieved, increasing the tolerance to dispersion. The information is decoded at the receiver with a fibre interferometer providing a 1 bit delay.
M-ary PSK—Multiple phase shift keying. A set of signals that may be generated in a poly phase signal set. Advantage—Symbol rate has further reduced the bit rate. Disadvantage—complexity of coding information, M no. of interferometers required to decode information at the receiver.
QAM—Quadrature amplitude modulation—Combination of amplitude modulation and phase shift keying. 4 QAM is equivalent to QPSK. 16 QAM has 4 states in each quadrant and therefore has a complicated algorithm to change state, involving transition through other states.
Inverse Multiplexing—high aggregate bit rate (B) transmitted on multiple (N) channels, each at a reduced bit rate (B/N) gives increased transmission distance but also an increase in the component count.
Dual polarisation—launching independent information in orthogonally polarised states, which results in an increase in the component count in order to separate the different polarization states at the receiver. Non linear interaction of polarization states can occur in the fibre due to the Kerr effect.

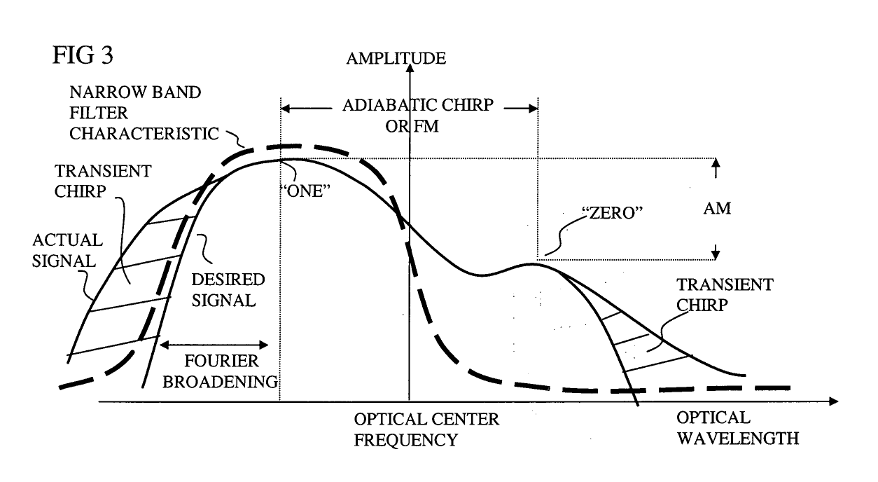

In the receiver, a narrow band offset filter 60 is provided, before the signal is converted to the electrical domain by O/E converter 70, then decoded by decoder 80 to recover the data. The type of decoding will depend on the type of modulation. For some types of modulation, additional or modified optical components are used. The filter has a particular pass band to enable it to remove transient chirp and to reduce the FM-AM phase difference. An example of such a pass band is shown in FIG. 3.

FIG. 3 shows a graph showing a frequency or wavelength spectrum of an optical signal before filtering, and a characteristic of the filter of an embodiment superimposed. The X axis represents optical wavelength or 1/frequency, and the Y axis represents the signal power, or the power transmission response of the filter. In this case the spectrum of the modulated signal is spread either side of an optical-center frequency. On the left is a peak representing a logical “one” and on the right is a lower peak representing a logical “zero”. The frequency difference between these peaks represents an amount (or magnitude) of FM, some of which is intentionally modulated, and part of which is unwanted chirp, arising from the nature of the laser, and the difficulty in controlling amplitude and phase independently. A difference in height of the two peaks represents a depth of AM modulation. The receiver can exploit both the AM and the FM in this case to distinguish the ones from the zeroes and from noise.

The signal spectrum spreads beyond the adiabatic FM spread, due to Fourier broadening. The amount of such broadening is proportional to the data rate. This gives one limit as to how close in wavelength neighbouring channels in a WDM system can be. Transient chirp or ringing appears in the spectrum as a further unwanted broadening of the spectrum, shown by shading. The further it extends in frequency, the heavier is the dispersion penalty, as such components “run into” the preceding or succeeding bit, owing to their slower or faster transmission speed along dispersive fiber. The pass band of the narrow band filter is shown as a dashed line. It has a band center frequency offset from a central optical frequency of the optical signal, to reduce a phase difference between FM and AM of the modulated optical signal. The filter has this effect because it is asymmetrical about the central optical frequency. In practice a Gaussian profile can give good results. In this case the peak of the band is close to the “ones” peak of the signal spectrum. In principle it could be the other side of the central optical frequency, to pass the “zeroes”, but this would waste optical power. It has a bandwidth sufficiently narrow to substantially remove frequencies outside a spectrum of adiabatic frequency chirp resulting from the modulation, combined with Fourier broadening caused by the data, thereby reducing the magnitude of the transient frequency chirp. This may result in some loss of power in the useful data part of the spectrum, but in many cases, the disadvantage of this is outweighed by the further improvement in dispersion tolerance.

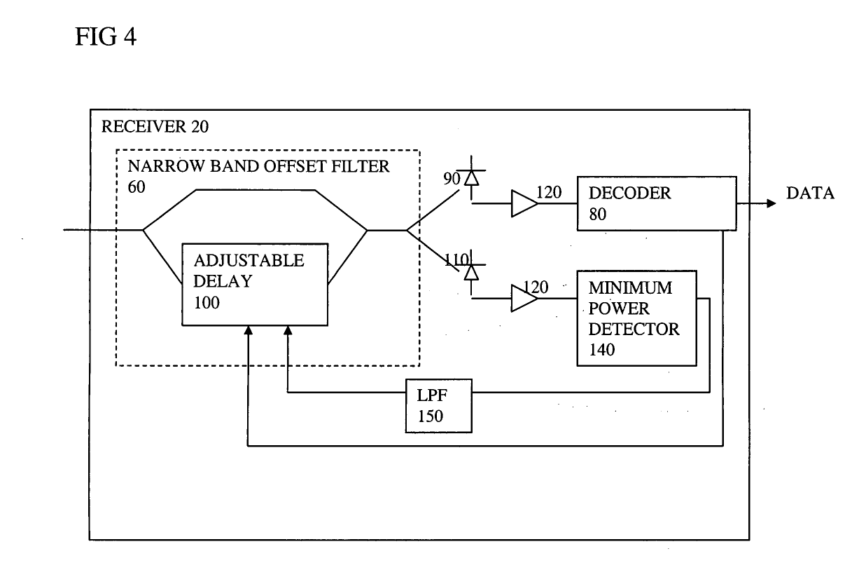

FIG. 4,5 Receiver

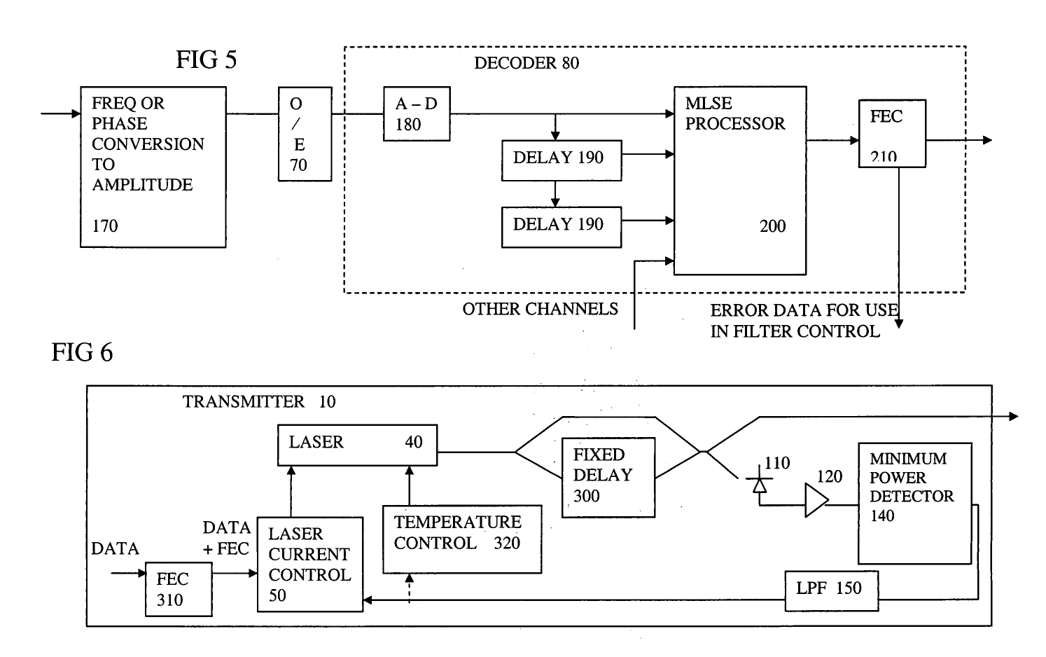

FIG. 4 shows an embodiment of a receiver 20 which may be used in the system of FIG. 2, or in other systems. It includes a narrow band filter 60 in the form of a Mach Zehnder having active control of wavelength relative to a central wavelength of the modulated signal. In this case, the wavelength of the band is controlled by adjusting the path length or delay 100 of one branch of the Mach Zehnder. One output of the Mach Zehnder is used for recovering data, being fed to a detector 90, and feedback amplifier 120 before the analog electrical signal is fed to a decoder 80. The decoder may include clock recovery, and use fixed or adaptive thresholds for distinguishing ones from zeroes by phase and amplitude. There can be multiple threshold levels for some modulation formats. Or the decoder may use digital processing techniques such as MLSE, described below with regard to FIG. 5. The decoder outputs the recovered data. The decoder can output an indication of received signal quality such as Q value, FEC correction rate, or eye opening, or other values. This can be used to control the filter band wavelength. This should have the effect of locking the filter to the laser wavelength because laser wavelength drift would cause the signal quality to drop.

Also shown is a power monitor function for controlling the filter with the object being to maximize the received power on detector 90 and minimize the monitored power on detector 110 which is fed to amplifier 120. This can be used instead of or as well as the quality indication. These need not be as high quality as the components used for the data path. The power monitor signal is fed to a minimum power detector 140 and low pass filter 150, to produce a smoothed low frequency control signal. This can enable the filter to be controlled to maximize the power output on detector 90. This should have the effect of locking the filter to the peak of the “ones” in the signal spectrum, and therefore locking to the laser wavelength. Other types of narrow band filter can be used, such as a FP or FBG filters. The power or quality signal or both signals can optionally be fed back to the transmitter side over a slow (KHz or Hz) rate management link to help control the laser, instead of or as well as controlling the filter.

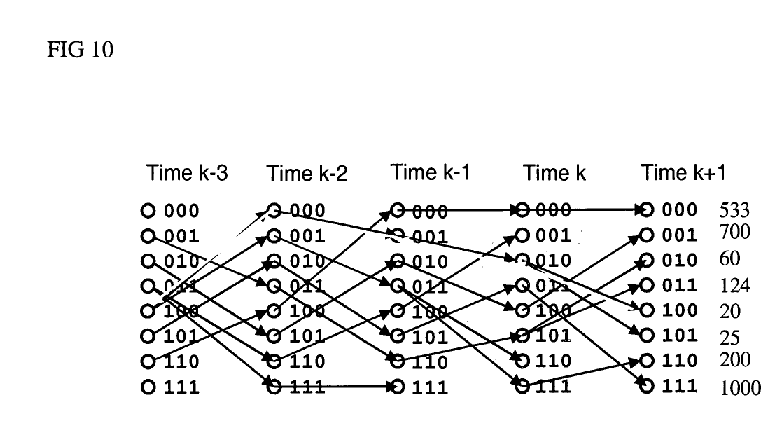

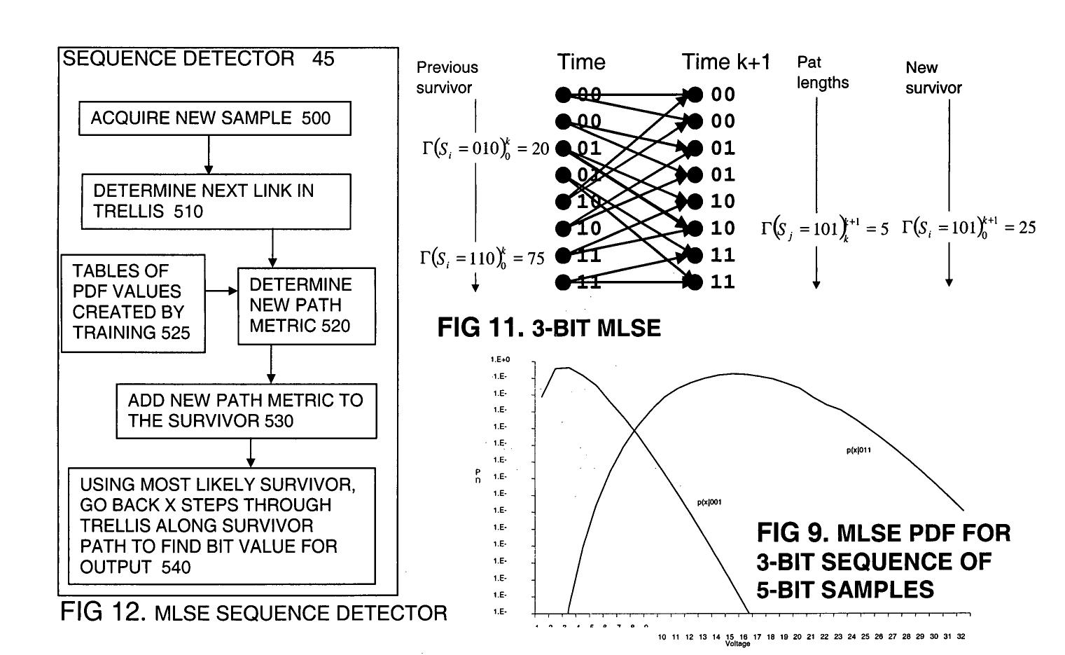

FIG. 5 shows a decoder and other parts of a receiver, for use as an alternative to parts of the receiver of FIG. 4, or in other receivers. In particular the decoder of FIG. 4 can be replaced by the decoder of FIG. 5. A sloping filter characteristic can be used as a frequency or phase to amplitude conversion means 170 for converting to amplitude in the optical domain. This can take the place of, or complement the narrow band filter of FIG. 4. This is followed by a converter 70 for converting to the electrical domain, and the analog electrical signal is fed to the decoder 80. This has an analogue to digital (A/D) converter 180, for generating a two or more bit digital representations of the optical power at each transmitted data bit. This is followed by digital MLSE processing circuitry. Optionally two or more delays 190 are used to create a set of parallel digital signals to enable the MLSE processing to be carried out in parallel for more speed or to enable a slower clock rate. Each transmitted data bit can be represented as a digital value. The sequence is fed to a processor 200, which includes look up tables constructing from training data or adaptive estimation, that enables the most likely bit sequence to have been transmitted to be estimated from the received sequence. Thus the output depends on the digitized (two or more bit) values of the raw, un-decoded, preceding and succeeding analogue data bits. As shown, simultaneous data bits from neighbouring channels can also be fed in. Thus some inter symbol and inter channel interference can be overcome, provided it is deterministic and not random, and provided the tables are filled with accurate values predetermined by training, or active adaptation, for the behaviour of that system. This will be described in more detail below with respect to FIGS. 9, 10, 11 and 12 below.

Following MLSE decoding, the data values can be fed to a FEC processor 210 for bit error detection and correction. This outputs the best estimate of the transmitted data, and can output an error rate signal to represent received signal quality, for use elsewhere, such as in controlling the narrow band filter, or other dispersion compensators or equalizers or amplifiers for example. The digital circuitry can be implemented in hardware following established principles. Parallelism can be used to enable use of digital clock rates lower than the data rate. Circuitry with clock rates approaching or exceeding 10 GHz has been demonstrated and is expected to become commercially available.

FIGS. 6, 7, 8 Transmitter

FIG. 6 shows a transmitter according to another embodiment. In this case, the narrow band filter is located in the transmitter rather than the receiver. The laser 40 is directly modulated, having its current varied by a laser current control part 50 according to a desired modulation format. The data is optionally supplemented by FEC redundant data by FEC processor 310, following established practice. The filter is locked to the laser 40 by a feedback loop to control the laser wavelength, or to adjust the filter wavelength. (In practice the laser will probably contain some coarse frequency control element, such as a FP etalon, to keep the laser frequency within some specified range of the appropriate ITU channel grid frequency.) The wavelength of a semiconductor laser tends to change with aging, current and temperature. The feedback from the narrow filter could be used to fine tune the laser frequency. Alternatively it might be possible to combine the two filter functions so as to control the laser frequency relative to the narrow filter and the ITU grid position). The filter is coupled to the output of the laser. The filter comprises a Mach Zehnder with a fixed delay 300 in one branch. One output of the Mach Zehnder is the transmission signal, which is optionally amplified before transmission. Another output of the Mach Zehnder is conveniently used as a power monitoring tap. This is converted to an electrical signal by detector 110 and fed through an amplifier 120, if necessary, to a minimum power detector 140. After smoothing by a low pass filter 150, the power signal is fed back to control the center frequency of the laser 40. This can be done by a temperature controller 320 for example or by means of the laser current control. Typically the center frequency is locked to maximise the mean output power from the filter coupled into the transmission fibre, by comparing an output of the laser before and after filtering.

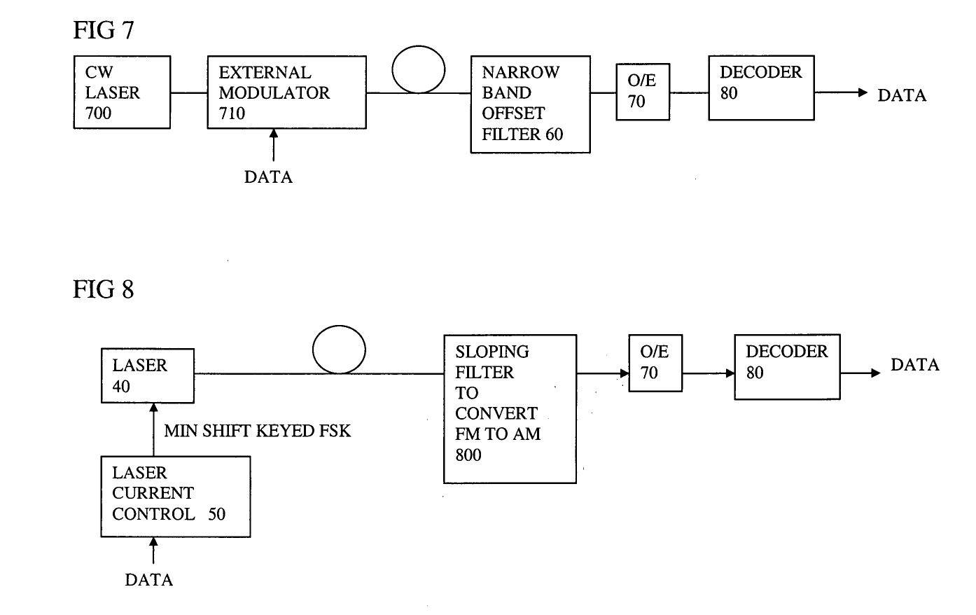

FIG. 7 shows another embodiment of a transmitter, and associated transmission system and receiver, using an externally modulated laser with laser 700 feeding an external modulator 710. The receiver can be as in FIG. 4 or 5, with a narrow band offset filter, or the narrow band filter can be at the transmitter side.

FIG. 8 shows an example of a transmission system and receiver with a transmitter without a narrow band filter. In this case, the directly modulated laser 40, is controlled by the laser current control part 50 to provide small or minimum shift keyed FSK modulated data. At the receiver, a filter 800 has a sloping response to convert FM to AM, which is then detected as before. This can provide good dispersion tolerance even without the narrow band filter. The sloping filter enables the FM to AM phase difference to be reduced, and the small amount of FM modulation can provide improved extinction ratio and thus greater tolerance to the dispersion.

FIGS. 9-2 MLSE

Examples of sequence detectors include MAP (maximum a posteriori) and MLSE algorithms. An example of an MLSE algorithm will now be described with reference to FIGS. 9-12. Instead of making decisions on individual bits, maximum likelihood detectors make decisions on sequences of bits (symbols). Ideally, given a noisy set of samples of the received data sequence x, the symbol (S) that maximises the probability p(S|x) is selected. This is called the maximum a posteriori probability. If it is assumed that symbols are equally likely (e.g. equal numbers of 0's and 1's, or equal numbers of 00, 01, 10, 11, etc), then Bayes law can be used to look for the symbol which maximises p(x|S). This is the maximum likelihood sequence estimator (MLSE), which operates by searching through each symbol S, and selecting that which has the highest probability of generating a noisy data sample x. It is equally valid to search for the symbol that maximises the log-likelihood probability ln [p(x|S)], since it varies monotonically with p(x|S).

If it is assumed that the noise on each sample is independent (this may not be strictly true for fractional samples, which are spaced at an interval that is a sub-multiple of the bit period, since they are correlated by the low pass electrical filter), then the log likelihood breaks up into a sum of independent probabilities for individual bits:

$$ln [ p ( x \vert S ) ] = {\sum }_{k} ln [ p ( {x}_{k} \vert S ) ] \qquad Eq 1$$

If we know the probability distribution for each bit of each symbol S, we can calculate the total log-likelihood probabilities for different sequences. The most probable sequence of symbols can be selected. It is possible in principle to have a sequence of a single bit but this does not offer useful functionality, and 3 or 5 bits are often suitable. The threshold is set to minimise the sum of the errors produced by 1's and 0's. For cases where there is no ISI, each bit is independent and a complex MLSE acting over sequences of bits longer than 1 will perform no better than a standard decision threshold detector.

The MLSE algorithm is initially trained using a data set with noise that is independent of the measurement data. With knowledge of the actual bit sequence, this training data is used to create probability tables P(xₖ|S), for each state (S). FIG. 9 shows an example of a graph of a PDF table generated for a case with 100 ps of PMD, with two density functions shown. For clarity, the MLSE displayed here makes decisions based on 3 bits, so there are 8 states of which only two are shown for the sake of brevity. Such tables can be created using training sequences following established principles. For a 3 bit MLSE, the PDFs are generally created based around the central bit. This is appropriate if the transmission-induced distortion arises in approximately equal measure from the two adjacent bits both before and after the decision bit. However situations may arise when either the distortion from the preceding or the succeeding bits dominates over the other, in which case the decision bit can be moved to be the first or third bit in the symbol as is appropriate. The decision timing of the samples is optimised. It can be seen that in the presence of distortion such as PMD, the PDF of the voltages is dependent on adjacent bits.

Since there is only a finite amount of training data, a fitting function is used to interpolate the PDF where there is little or no training data. For square-law receivers, a root-Gaussian fitting function can be used where the PDF depends on the root of the detected voltage or the amplitude of the field on the detector, whereas coherent receivers have a Gaussian fitting function applied, where the detected voltage is proportional to incident field. The resulting PDFs are shown as the solid lines in FIG. 9.

Viterbi Algorithm

A maximum likelihood detector bases its decisions on sequences of bits. Each sequence of bits is called a symbol (symbol used above). When a new bit enters the detector, the routine determines the most likely symbol to have been transmitted. It is impossible for the symbol to change from 111 to 000 when advancing one bit. The two possible changes might be from 111 to 110, or to remain at 111. The well known Viterbi algorithm makes use of the fact that the noise (as opposed to ISI) on each sample is independent. The total log likelihood becomes the sum of independent probabilities for each bit:

$${Γ ( S )}_{{k}_{1}}^{{k}_{2}} ≡ {\sum }_{k = {k}_{1}}^{{k}_{2} - 1} ln [ p ( {x}_{k} \vert S ) ] \qquad eq . 2$$

The Viterbi algorithm creates a trellis of connections or paths between the potential states for each bit. The length of the path is an indication of the probability of the transition. The log-likelihood probability of moving from symbol Sᵢ at time t=k, to a new symbol S₁ at time t=k+1 may be calculated as the sum of two independent parts:
Γ(Sⱼ)₀^{k+1}≡Γ(Sᵢ)₀^{k}+Γ(Sⱼ)ₖ^{k+1} eq. 3
where Γ(Sⱼ)₀^{k+1} is the new path length, Γ(Sᵢ)₀^{k} is the previous survivor length and Γ(Sⱼ)ₖ^{k+1} is the path length.

Since a binary system is used, each new state can only be arrived at from one of two previous states. The Viterbi algorithm creates a trellis of connections between states, discarding connections that are least likely. A full explanation of the Viterbi algorithm can be found in standard textbooks, and so need not be set out in more detail here. FIG. 10 shows a trellis of surviving paths built up over several sample periods, k−3 to k+1, with many paths, and a score indicating a probability for each path. FIG. 11 shows a subset of the trellis to show how the survivors are determined out of many possible paths. It shows how symbol 101 at time k+1 may be reached from either symbol 010 or 110 at time k. However, since the survivor length of state 010 is less than that of 110, only the connection 010->101 is retained. A new survivor length is created by adding the path length calculated at time t=k+1, using the probability tables described above with reference to FIG. 9.

At this stage no final decision has been made as to the most probable bit at time t. In principle the Viterbi algorithm can make a final decision when all the data has arrived, and the trellis converges on a final state. In practice, where there is a continuous flow of data, it is usual to wait a finite time δ. If δ is long enough, all paths at time t=k will converge on the same state at time t=k−δ. In this implementation an initial search is used to find the smallest survivor length at time t=k. The trellis is then traversed from this initial state back to state t=k−δ and a hard decision is made. This is shown in FIG. 10 where the trellis path for state 100 at time k+1 has the lowest score and thus highest likelihood.

To find the surviving paths, the path is traversed from symbol 100 at time t=k+1 to time t=k−3, where the path shows symbol 100. Now that this is confirmed as the best path at that time, the central value 0 at time t=k−3 can be output as the data. A sliding window is used so that the trellis length is maintained at depth δ.

The length of the trellis is dependent on the number of states and the method of searching back through the trellis. If an initial search is used to select the initial state with lowest survivor path length then the trellis length can be reduced (this is the method used here). However, this comparison is a complex operation, especially for large numbers of states. It can be more computationally efficient to use a large trellis length and select an arbitrary initial path.

FIG. 12, MLSE Overview

In FIG. 12 an overview of some of the principal steps in an MLSE using the Viterbi algorithm are illustrated. A new sample is acquired at step 500 from each of the component signals. At 510 a next link in the trellis is discovered. Tables of PDF values 525 are used to determine new path metrics (or path lengths) at 520. The new path metrics are added to the survivors at step 530 to create new survivor lengths. Each survivor is a different path through the trellis of possible sequences. The survivor length values indicate the likelihood of a sequence defined by the respective survivor. The smallest survivor length is found and this indicates the sequence with the maximum likelihood. At step 540 a central bit of that sequence is output by following the survivor path back through the trellis.

As discussed above, FIG. 11 shows a small part of a trellis for a three-bit MLSE. The eight possible three-bit sequences are shown at time k with arrows leading to the next possible three-bit sequence at time k+1. A column of previous survivor lengths up to time k is recorded, with two examples being illustrated. At time k+1 the path lengths for the most likely of the two sequences leading to each state are recorded (one is illustrated having a value of 5). This is added to the shortest of two possible survivor lengths (20 in the example illustrated) to give the new survivor length for each of the eight possible three-bit sequences at time k+1 (resulting in a new survivor length of 25).

Over Sampling

An A/D converter may be used that supplies more than 1 sample per bit. In coherent transmission, samples may be available from both the in-phase (I) and quadrature (Q) ports. Extra probability tables are stored for this extra information. This doubles the number of tables required for fractional sampling at 2 samples/bit, or for decisions made using both I and Q ports. If fractional samples are used on I and Q ports, a four-fold increase in memory is needed. Each path length is determined as follows
Γ(Sⱼ)ₖ^{k+1}=Γ(Sⱼ)ₖ^{k+1}|ₛₐₘₚₗₑ₁+Γ(Sⱼ)ₖ^{k+1}|ₛₐₘₚₗₑ₂ . . . Γ(Sⱼ)ₖ^{k+1}|_{sampleN} eq. 4

This assumes statistical independence between the samples. An option is to take into account the correlation between samples caused by filtering at the receiver, to improve the effectiveness of the algorithm.

Other Embodiments, Remarks

Although other channels are not shown, any of the embodiments can be used in WDM systems. In one embodiment minimum shift keying of 5 GHz (not 0 GHz) of adiabatic FM at 10 Gb/s can be used, if FM is in-phase with AM. This is essentially independent of extinction ratio. It implies a modulation current of 50 mA given say an FM efficiency of 0.1 GHz/mA for a typical DFB laser. Operating the laser at a higher power, which shortens the differential carrier lifetime, reduces the timing delay of AM with respect to FM. For example, increasing drive current from 50 to 100 mA has been shown from simulations to reduce the timing advance of the FM with respect to the AM from approximately 18 to 12 ps. In addition, operating the DFB laser at higher power increases the damping of transient response, thereby reducing its contribution to the dispersion penalty at >4000 ps/nm. However it is generally true that the reliability of semiconductor lasers reduces with increasing injected current density, output power and temperature. Another option is to design a DFB laser optimized to operate with high photon density in the active region(s), at moderate output powers and current densities, by reducing the width of the guided mode perpendicular to the plane of the junction.

A number of other techniques can be used for reducing transient effects at ASK pulse edges. Single pole filtering of the drive current can reduce the abruptness of the current pulse edges. This is easy to implement, but can give significant back-to-back eye closure, and therefore significant back-to-back ISI. Notch filtering can be used to remove a component of the drive current waveform at the laser resonance frequency in the ‘1’s. This gives more suppression of frequency transients. Finally, the use of a pre-biasing current pulse before the main current pulse, followed by a slow current increase to the ‘one’ level, can be applied at each ‘0’ to ‘1’ transition. This can give good suppression of transients, but a larger bandwidth current drive is required. Filtering of the laser drive current can include a transversal filter. This can be optimized by adjusting tap weights on the transversal filter used to filter the laser drive current waveform. This can be done with respect to overall end to end system performance. Another alternative is to use a push-pull laser (ref. 1: M. C. Nowell, ‘Push-pull directly modulated laser diodes’, Ph.D. dissertation at Cambridge University, October 1994, ref. 2: B. J. Flanigan, ‘Advances in push-pull modulation of lasers’, Ph.D. dissertation at Cambridge University, November 1996). These have better dispersion tolerance than conventional directly modulated DFB lasers. A push-pull laser is a split contact DFB with the two end sections driven in anti-phase. The total current does not vary with time. Modulation is achieved by moving the photon population up and down the cavity, rather than repeatedly quenching and re-establishing the photon population as in conventional lasers. This can lead to much higher resonance frequencies, larger damping rates and fixed high photon densities which may reduce the significance of transient effects. The adiabatic chirp is zero for anti-symmetric current modulation of two sections, but can be tailored by unbalancing the modulation amplitudes. Introducing a time delay between the two modulation currents will add positive or negative frequency chirp at edges of pulses.

As described above, a narrow optical filter, approximately centred on the frequency of the transmitted digital ‘ones’ and with an optimised bandwidth, can extend the chromatic dispersion tolerance of a directly or externally modulated DFB laser transmission system. The embodiments can encompass many modulation types including notably pure ASK, pure FSK and mixed FSK and ASK transmission formats. One embodiment involves a 10 Gb/s system using a commercially available DFB laser with 5 GHz of adiabatic FSK and with an ASK extinction ratio of approximately 5:1. A reach in the order of hundreds of km of NDSF can be achieved at 10 Gb/s for BER of 10⁻³ and an OSNR of 15 dB using an adaptive receiver. This is extended further if a 2 samples/bit 5 bit maximum likelihood sequence estimator (MLSE) is used at the receiver. No dispersion compensation modules or external modulators are required in the system for this performance, with the narrow optical filtering reducing the dispersion penalty. This opens up the possibility of developing low cost 10 Gb/s optical transmission systems suitable for deployment in regional networks.

The narrow optical filter can have active control to maintain the centre frequency at its optimum value. This can use for example, a Mach-Zehnder filter by adjusting the optical path length difference between the two arms using feedback from an optical power monitor or from the FEC software in the receiver. The Mach-Zehnder could be realised in fibre or a passive waveguide circuit, with the latter being potentially integrated with the laser. The filter could be placed at the transmitter or receiver, with the latter offering better noise performance.

One example of the narrow optical filter, has a −3 dB bandwidth of approximately 8 GHz centred on an optical frequency close to that corresponding to the digital ‘ones’, This largely removes the FM advance on the AM and hence the dispersion penalty at about 1000 ps/nm. For the most common single mode fiber, having a dispersion of approximately 17 ps/(nm.km), this corresponds to a distance of approximately 60 km for 10 Gb/s signals. At dispersions of about 6000 ps/nm the transmission distance is limited by the frequency and amplitude transient response of the laser which is excited when switching between the digital ‘zero’ and ‘one’ levels. The use of a narrow optical filter can extend this tolerance also to about 11000 ps/nm in the presence of a MLSE by partially filtering out the transient frequency ringing.

As has been described above, an optical transmission system has a directly modulated laser for modulating data directly on an optical signal, and a narrow band optical filter having a band center frequency offset from a central optical frequency of the optical signal, to reduce the phase difference between FM and AM of the modulated optical signal, the filter having a bandwidth sufficiently narrow to substantially remove frequencies outside the spectrum of the adiabatic frequency chirp resulting from the modulation, combined with Fourier broadening caused by the data modulation. This is a cost effective way of improving dispersion tolerance to give greatly improved system reach to make it practical to use directly modulated lasers with existing NDSF. The narrow band filter can be located at the transmitter or the receiver. It can have a center frequency locked to some feature in the laser frequency spectrum. Other variations will be apparent to those skilled in the art, having corresponding advantages to those set out above, within the scope of the claims.

1. A system having a transmitter for transmitting an optical signal along a transmission path, the transmitter having a directly modulated laser for modulating data directly on the optical signal, the system having a receiver for receiving the transmitted optical signals to recover the data, and a narrow band optical filter having a band center frequency offset from a central optical frequency of the optical signal, to reduce a phase difference between FM and AM of the modulated optical signal, the filter having a bandwidth sufficiently narrow to substantially remove damped oscillatory transients in frequency that fall outside the spectrum of adiabatic frequency chirp resulting from the modulation, combined with Fourier broadening caused by the data.

2. The system of claim 1, the bandwidth being narrower than the spectrum of adiabatic frequency chirp resulting from the modulation, combined with Fourier broadening caused by the data.

3. The system of claim 1, the modulation comprising frequency modulation with a magnitude of less than twice the data rate (i.e. less than 20 GHz at 10 Gb/s).

4. The system of claim 3, the transmitter being arranged such that the magnitude of the frequency modulation is approximately half the data rate.

5. The system of claim 1, the system having active control of the center frequency of the filter relative to the center frequency of the optical signal.

6. The system of claim 1, the filter center frequency being controlled based on a monitored quality of a received signal at the receiver.

7. The system of claim 1, the filter center frequency being controlled based on the optical signal power after the filter.

8. The system of claim 1, the receiver being arranged to receive optical signals having a number of WDM channels, and the filter being arranged to pass one desired channel or band of channels, and reject the others.

9. The system of claim 1, the filter comprising a Mach Zehnder with an adjustable path length difference.

10. The system of claim 1, the receiver having an electrical signal processor arranged to carry out sequence detection to decode the data.

11. The system of claim 1, the receiver having forward error correction (FEC) circuitry.

12. The system of claim 1, the filter being located at the receiver.

13. The system of claim 1, the filter being located at the transmitter.

14. A system having a transmitter for transmitting an optical signal along a transmission path, the transmitter being arranged to modulate data on the optical signal, the system having a receiver for receiving the transmitted optical signals to recover the data, and a narrow band optical filter for passing frequencies at one side of a central optical frequency of the optical signal, the modulation comprising frequency modulation with a magnitude less than approximately twice a rate of the data.

15. The system of claim 14, the transmitter having a directly modulated laser.

16. A transmitter for transmitting an optical signal along a transmission path, the transmitter having a directly modulated laser for modulating data directly on the optical signal, and a narrow band optical filter having a band center frequency offset from a central optical frequency of the optical signal, to reduce a phase difference between FM and AM of the modulated optical signal, the filter having a bandwidth sufficiently narrow to substantially remove frequencies outside a spectrum of adiabatic frequency chirp resulting from the modulation, combined with Fourier broadening caused by the data.

17. A receiver for receiving an optical signal modulated with data, to recover the data, and having a narrow band optical filter having a band center frequency offset from a central optical frequency of the optical signal, to reduce a phase difference between FM and AM of the modulated optical signal, the filter having a bandwidth sufficiently narrow to substantially remove transient chirp frequencies.

18. A method of offering a communication service over an optical communication system having a transmitter for transmitting an optical signal along a transmission path, the transmitter having a directly modulated laser for modulating data directly on the optical signal, the system having a receiver for receiving the transmitted optical signals to recover the data, and a narrow band optical filter having a band center frequency offset from a central optical frequency of the optical signal, to reduce a phase difference between FM and AM of the modulated optical signal, the filter having a bandwidth sufficiently narrow to substantially remove frequencies outside a spectrum of adiabatic frequency chirp resulting from the modulation, combined with Fourier broadening caused by the data.

19. A method of offering a communication service over an optical communication system having a transmitter for transmitting an optical signal along a transmission path, the transmitter being arranged to modulate data on the optical signal, the system having a receiver for receiving the transmitted optical signals to recover the data, and a narrow band optical filter for passing frequencies at one side of a central optical frequency of the optical signal, the modulation comprising frequency modulation with a magnitude less than approximately twice a rate of the data.

20. The method of claim 19, the transmitter having a directly modulated laser.

21. A transmitter for transmitting an optical signal along a transmission path, the transmitter being arranged to modulate data on the optical signal and having a narrow band optical filter for passing frequencies at one side of a central optical frequency of the optical signal, the modulation comprising frequency modulation with a magnitude less than approximately twice a rate of the data.

22. The transmitter of claim 21 having a directly modulated laser.

23. A receiver for receiving and for recovering data from an optical signal having the data modulated thereon, the modulation comprising frequency modulation with a magnitude less than approximately twice a rate of the data, the receiver having a narrow band optical filter for passing frequencies at one side of a central optical frequency of the optical signal.
